(19) United States
(12) Patent Application Publication
(10) Pub. No.: US 2026/0257182 A1
(43) Pub. Date: Sep. 3, 2026

(54) MULTI-AXIS AGITATION APPARATUS WITH SELF-CENTERING NECK CLAMP FOR MULTI-VESSEL HANDLING

(71) Applicant: Jordan Stoyanov Bonev, Haworth, NJ (US)

(72) Inventor: Jordan Stoyanov Bonev, Haworth, NJ (US)

(21) Appl. No.: 19/653,196

(22) Filed: Apr. 21, 2026

(51) Int. Cl. B01F 31/20; B01F 31/00; B01F 31/50

(52) U.S. Cl. CPC B01F 31/201; B01F 31/50; B01F 31/70

(57) ABSTRACT

A multi-axis agitation apparatus for mixing or processing fluids contained within a plurality of vessels. The multi-axis agitation apparatus comprises a movable platform, a plurality of clamp assemblies, and a motion actuation assembly. The multi-axis agitation apparatus provides improved adaptability to different vessel sizes, enhanced stability through self-centering clamping, and user-controlled adjustment of agitation intensity. The multi-axis agitation apparatus further enables simultaneous and uniform agitation of multiple vessels, thereby improving throughput and operational efficiency. The multi-axis agitation apparatus provides a plurality of clamp assemblies configured to secure vessels through engagement with a neck portion, thereby enabling accommodation of vessels having varying diameters without requiring dedicated clamp geometries. The multi-axis agitation apparatus ensures uniform distribution of clamping forces across multiple contact points, thereby improving stability and reducing risk of vessel damage.

### FIELD OF INVENTION

The present disclosure relates generally to laboratory equipment, and more particularly to agitation systems configured for mixing or processing fluids contained within vessels. The disclosure relates to a multi-axis agitation apparatus capable of providing controlled motion to a plurality of vessels.

### BACKGROUND

Agitation systems, such as laboratory shakers, mixers, and orbital platforms, are widely used in scientific, medical, and industrial environments for mixing fluids, suspensions, or other materials contained within vessels. These systems typically impart motion to a plurality of vessels to facilitate mixing, reaction, or processing.

Conventional agitation systems generally employ clamp mechanisms to secure vessels to a platform. In many implementations, such clamp mechanisms are designed for specific vessel sizes or geometries and may rely on elastic deformation, spring-loaded elements, fixed holders, or magnetic attachment methods. For example, systems such as those disclosed in U.S. Pat No. 8,721,993B2 utilize magnetically attachable clamps with elastomeric components and positioning features to retain vessels on a shaker platform. While such approaches provide ease of placement and removal, they rely on magnetic fixation and predefined geometries, which may limit adaptability and consistent force application across vessels of varying sizes.

Similarly, other known clamp designs, such as those described in U.S. Pat. No. 12,440,813B2, employ holding arms with flat contact surfaces and resilient tensile elements to secure containers, particularly angular bottles, through surface contact. These configurations are generally tailored to specific container shapes and rely on two-dimensional surface engagement, which may not be suitable for vessels having varying geometries or neck configurations.

In many existing systems, vessel retention mechanisms engage a body portion of the vessel rather than a neck portion. Such arrangements may result in inconsistent alignment, localized stress concentrations, or non-uniform force distribution, particularly when vessels of different shapes or sizes are used. Furthermore, clamp designs that depend on elastic members or fixed geometries may not provide precise or repeatable clamping forces.

Existing agitation platforms are also commonly configured for single-axis or orbital motion. While such motion profiles are suitable for certain applications, they may not provide controlled multi-directional or true three-dimensional agitation while maintaining vessels in a desired upright orientation. Additionally, many systems are configured to accommodate a limited number of vessels or require dedicated holders for each vessel type, thereby reducing flexibility and throughput in multi-sample environments.

Further, adjustment of motion characteristics, such as amplitude or intensity, in conventional systems is often achieved through variation of motor speed or electronic control systems. Such approaches may introduce operational complexity and may not provide simple, direct, and reliable mechanical adjustment of motion parameters.

Therefore, there remains a need for an improved agitation apparatus capable of accommodating vessels of varying sizes, securely retaining such vessels with consistent and uniform force distribution, and providing controlled multi-axis motion. There is also a need for a system capable of simultaneously agitating multiple vessels while allowing for mechanically efficient and user-adjustable control of motion characteristics.

### SUMMARY OF THE INVENTION

The following presents a simplified summary of one or more embodiments of the present disclosure to provide a basic understanding of such embodiments. This summary is not an extensive overview of all contemplated embodiments and is intended to neither identify key nor critical elements of all embodiments, nor delineate the scope of any or all embodiments.

The present disclosure, in one or more embodiments, relates to a multi-axis agitation apparatus for mixing or processing fluids contained within a plurality of vessels. The multi-axis agitation apparatus comprises a movable platform, a plurality of clamp assemblies, and a motion actuation assembly.

An embodiment of the first aspect, wherein the movable platform is configured to support a plurality of vessels. The movable platform comprises a plurality of clamp stations arranged in a modular configuration.

An embodiment of the first aspect, wherein each of the clamp assemblies is mounted on the movable platform. Each clamp assembly comprises a support structure, and a movable clamping member. The support structure is mounted on the movable platform. The movable clamping member is actuated by at least one fastener. The movable clamping member is configured to engage a neck portion of a vessel. The movable clamping member is configured to move circumferentially relative to the neck portion during actuation of the fastener to thereby self-center the vessel and distribute clamping force across multiple contact points.

An embodiment of the first aspect, wherein the clamp assembly is configured to accommodate vessel neck diameters between 20 mm to 50 mm. The clamp assembly is configured to grip only the neck portion of the vessel.

An embodiment of the first aspect, wherein the movable clamping member is configured to provide at least eight circumferential contact points. The movable clamping member is configured for radial inward movement. The movable clamping member is free to rotate about respective dowels during tightening. In one embodiment, the movable clamping member comprises an upper plate and a lower plate. The upper plate and the lower plate are mechanically coupled to each other through a plurality of spacers. The spacers are configured to maintain a fixed separation between the upper plate and the lower plate and to define a structural assembly capable of guided movement relative to the support structures.

An embodiment of the first aspect, the fastener comprises a screw, wherein the screw comprises a tee-wing screw configured for manual tightening. The fastener comprises a linear rod and a torque bolt. The movable clamping member is guided by the linear rod and actuated by a torque-limiting fastener configured to restrict applied clamping force.

An embodiment of the first aspect, wherein the motion actuation assembly is operatively coupled to the movable platform. The motion actuation assembly is configured to impart multi-axis motion to the movable platform such that the movable platform moves along at least three axes intersecting at a common point while maintaining the longitudinal axis of each vessel substantially vertical during motion.

An embodiment of the first aspect, wherein the clamp assembly is configured for securing the vessel. The clamp assembly comprises the support structure, which is a static support structure. The movable clamping member is configured to engage the neck of the vessel.

An embodiment of the first aspect, the fastener comprises an actuation fastener configured to move the movable clamping member relative to the support structure.

An embodiment of the first aspect, the movable clamping member comprises a plurality of contact points. The contact points are configured to slide circumferentially around the neck during tightening of the actuation fastener to thereby automatically center the vessel and provide distributed contact forces.

An embodiment of the first aspect, the motion actuation assembly is configured for operating the movable platform. In one embodiment, the motion actuation assembly comprises a base, a driving unit, a motion conversion unit, and a multi-frame structure.

An embodiment of the first aspect, the driving unit is mounted to the base. The driving unit comprises a motor.

An embodiment of the first aspect, the motion conversion unit is operatively coupled to the driving unit. The motion conversion unit comprises a crank, and a roller. The crank is coupled to the driving unit. The roller is mounted on the crank with an adjustable offset. The motion conversion unit is configured to vary the adjustable offset of the roller relative to the crank. The motion conversion unit comprises an externally accessible screw configured to vary motion amplitude.

An embodiment of the first aspect, the multi-frame structure is disposed on the driving unit. The multi-frame structure comprises a plurality of frames arranged to allow motion along orthogonal axes that intersect at a common point. The multi-frame structure comprises an inner frame, a middle frame, and an outer frame corresponding to X, Y, and Z axes.

An embodiment of the first aspect, the movable platform is configured to support a plurality of vessels is mounted on the multi-frame structure such that rotation of the driving unit produces controlled multi-axis motion of the movable platform.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The accompanying drawings, which are incorporated in and constitute a part of the specification, illustrate an embodiment of the invention, and, together with the description, explain the principles of the invention.

FIG. 1 illustrates a perspective view of a multi-axis agitation apparatus, in accordance with embodiments of the invention.

FIG. 2 illustrates a perspective top view of the multi-axis agitation apparatus, in accordance with embodiments of the invention.

FIG. 3A illustrates an exploded view at least one of clamp assembly of the multi-axis agitation apparatus, in accordance with embodiments of the invention.

FIG. 3B illustrates an assembled view of the clamp assembly for securing the vessel, in accordance with embodiments of the invention.

FIG. 4 illustrates an exploded view of the multi-axis agitation apparatus, in accordance with embodiments of the invention.

FIG. 5A illustrates a perspective view of a motion actuation assembly for operating the movable platform, in accordance with embodiments of the invention.

FIG. 5B illustrates a perspective view of the multi-frame structure, in accordance with embodiments of the invention.

FIG. 5C illustrates a perspective view of the motion conversion unit without the multi-frame structure, in accordance with embodiments of the invention.

FIG. 6 illustrates a perspective view depicting mounting of the vessel on the multi-axis agitation apparatus, in accordance with embodiments of the invention.

FIG. 7 illustrates a perspective view depicting movement of the movable clamping member, in accordance with embodiments of the invention.

FIG. 8 illustrates a perspective side view of the multi-axis agitation apparatus, in accordance with embodiments of the invention.

FIG. 9 refers to a perspective side view of the clamp assembly, in accordance with embodiments of the invention.

### DETAILED DESCRIPTION

Reference will now be made in detail to the present preferred embodiments of the invention, examples of which are illustrated in the accompanying drawings. Wherever possible, the same reference numerals are used in the drawings and the description to refer to the same or like parts.

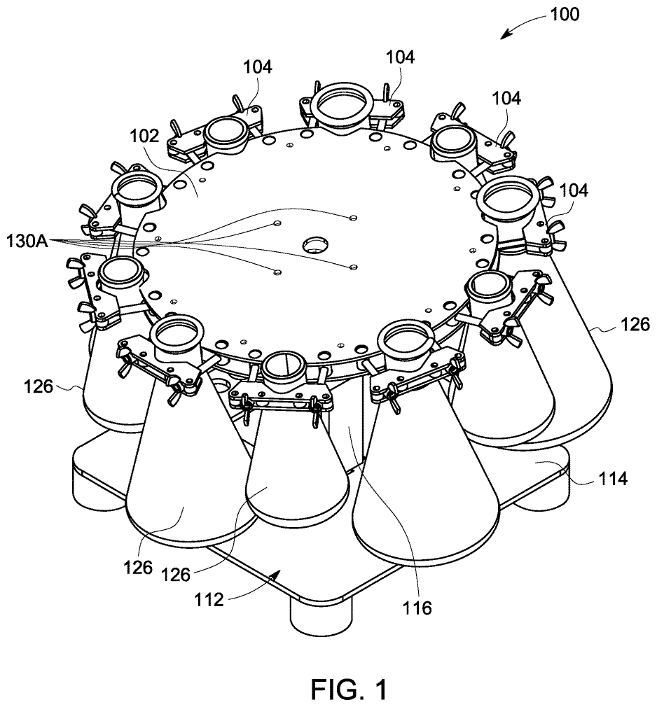

FIG. 1 refers to a perspective view of a multi-axis agitation apparatus 100 for mixing or processing fluids contained within a plurality of vessels 126. The multi-axis agitation apparatus 100 comprises a movable platform 102, a plurality of clamp assemblies 104, and a motion actuation assembly 112.

In one embodiment, the movable platform 102 is configured to support a plurality of vessels 126. The movable platform 102 comprises a plurality of clamp stations arranged in a modular configuration.

In one embodiment, each of the clamp assemblies 104 is mounted on the movable platform 102. Each clamp assembly 104 comprises a support structure 106, and a movable clamping member 108. The support structure 106 is mounted on the movable platform 102. The movable clamping member 108 is actuated by at least one fastener 110. The movable clamping member 108 is configured to engage a neck portion of a vessel 126. The movable clamping member 108 is configured to move circumferentially relative to the neck portion during actuation of the fastener 110 to thereby self-center the vessel 126 and distribute clamping force across multiple contact points.

In one embodiment, the clamp assembly 104 is configured to accommodate vessel necks having a wide range of diameters. In an example embodiment, the clamp assembly 104 is configured to accommodate vessel neck diameters in a range of about 20 mm to 50 mm, corresponding to a presently implemented prototype configuration. The clamp assembly 104 is configured to grip only the neck portion of the vessel 126 while leaving the body unsupported. In such embodiments, the clamp assembly 104 may be dimensioned or scaled accordingly while retaining the same structural arrangement and mode of operation of the clamp assembly 104. In such embodiments, the dimensions of the support structure 106, the movable clamping member 108, and the fastener 110 are selected to securely engage vessel necks within this range while maintaining self-centering functionality and distributed clamping forces. In some embodiments, the clamp assembly 104 is configured such that one or more of the support structure 106, the movable clamping member 108, spacing between components, and actuation travel of the fastener 110 are proportionally scalable. This enables the clamp assembly 104 to accommodate vessel necks of different sizes without altering the fundamental clamping mechanism, including circumferential movement of contact points and self-centering action. The specific dimensional ranges described herein are provided as illustrative examples and are not intended to limit the scope of the present disclosure. The clamp assembly 104 may be implemented for vessel neck diameters smaller or larger than the example ranges through appropriate scaling of component dimensions while preserving functional characteristics.

In one embodiment, the movable clamping member 108 is configured to provide at least eight circumferential contact points. The movable clamping member 108 is configured for radial inward movement. The movable clamping member 108 is free to rotate about respective dowels during tightening.

In one embodiment, the fastener 110 comprises a screw, wherein the screw comprises a tee-wing screw configured for manual tightening. The fastener 110 comprises one or more of a threaded fastener, a linear guide rod, and a torque-limiting fastener.

In one embodiment, the motion actuation assembly 112 is operatively coupled to the movable platform 102. The motion actuation assembly 112 is configured to impart multi-axis motion to the movable platform 102 such that the movable platform 102 moves along at least three axes intersecting at a common point while maintaining the vessels 126 in an upright orientation, meaning the longitudinal axis of each vessel 126 remains substantially vertical during motion within ±10° of vertical axis.

In one embodiment, the movable platform 102 comprises a plurality of holes 130A distributed at a center of the movable platform 102, as shown in FIG. 1.

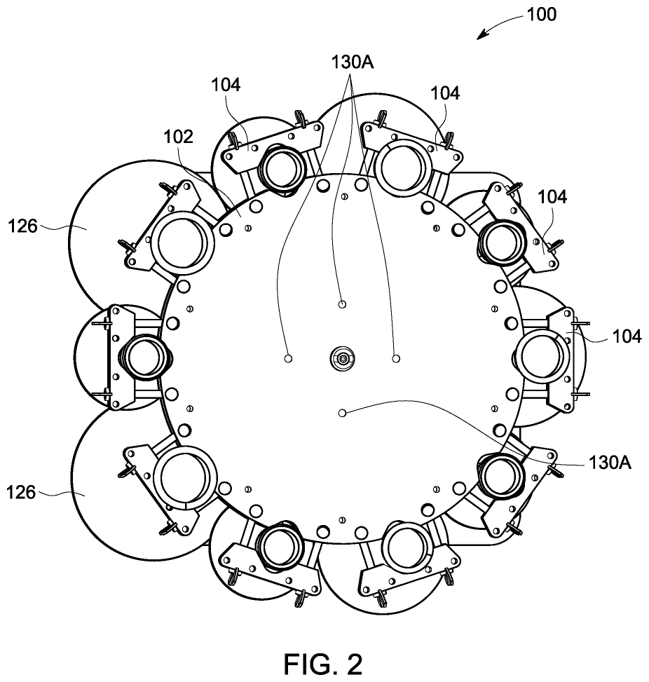

FIG. 2 refers to a perspective top view of the multi-axis agitation apparatus 100. The holes 130A are configured to receive fastener units (not shown) configured to secure the movable platform 102 to the motion actuation assembly 112. In one embodiment, the holes 130A extend through a thickness of the movable platform 102 to enable insertion of the fastener units from a top surface toward a rear surface of the movable platform 102. The fastener units are configured to engage corresponding mounting features provided on the motion actuation assembly 112 to establish a rigid mechanical connection between the movable platform 102 and the motion actuation assembly 112.

In one embodiment, the holes 130A are arranged in a predefined pattern corresponding to mounting locations of the motion actuation assembly 112 to ensure balanced load distribution during operation. The arrangement of the holes 130A is configured to maintain structural stability of the movable platform 102 under multi-axis motion conditions. In one embodiment, the holes 130A are configured as through-holes, threaded holes, or counterbored holes to accommodate different types of fastener units.

In one embodiment, the holes 130A are positioned to avoid interference with the clamp assemblies 104 and to maintain unobstructed mounting of the vessels 126. The holes 130A are further configured to facilitate assembly and disassembly of the movable platform 102 relative to the motion actuation assembly 112 for maintenance, replacement, or modular reconfiguration of the multi-axis agitation apparatus 100.

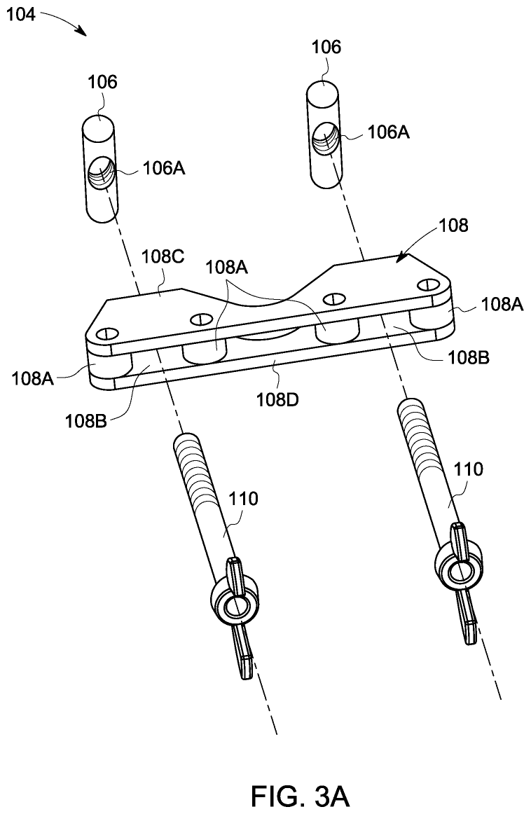

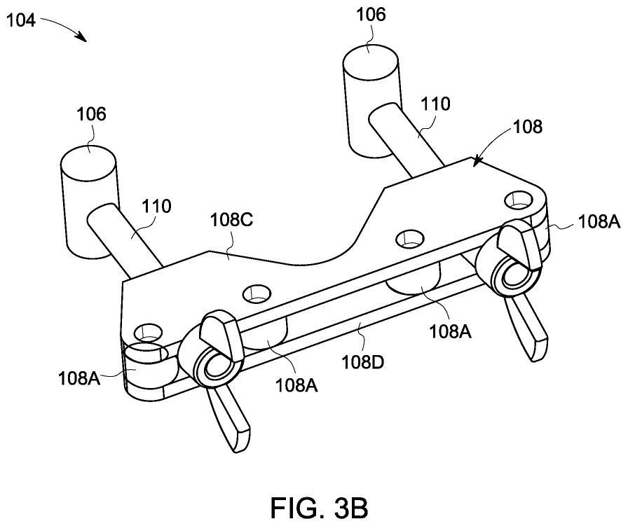

FIG. 3A refers to an exploded view at least one of clamp assembly 104. FIG. 3B refers to an assembled view of the clamp assembly 104 for securing the vessel 126. In one embodiment, the clamp assembly 104 comprises at least two support structures 106, wherein the support structures 106 are configured as static support structures. The support structures 106 are mounted on the movable platform 102 and are configured to provide a rigid framework for supporting the movable clamping member 108. The support structures 106 are further configured to maintain positional stability of the clamp assembly 104 during operation of the multi-axis agitation apparatus 100. In one embodiment, the support structures 106 are spaced apart to define a receiving region for accommodating the neck portion of the vessel 126 and to enable movement of the movable clamping member 108 relative to the vessel 126.

In one embodiment, the movable platform 102 comprises a first plate and a second ring plate. The first plate and the second ring plate are mechanically coupled to each other through the support structures 106 such that the support structures 106 extend between the first plate and the second ring plate. The first plate is configured to provide a base mounting surface for the clamp assemblies 104, while the second ring plate is configured to provide an upper structural frame aligned with the clamp assemblies 104. The support structures 106 are configured to maintain a fixed spatial separation between the first plate and the second ring plate, thereby forming a rigid and stable platform structure.

In one embodiment, the second ring plate comprises openings aligned with corresponding clamp stations to enable unobstructed access to the neck portions of the vessels 126. The arrangement of the first plate, the second ring plate, and the support structures 106 is configured to enhance structural rigidity of the movable platform 102 while minimizing weight and allowing unobstructed multi-axis motion.

In one embodiment, each of the support structures 106 is provided with at least one threaded hole 106A. The threaded hole 106A is configured to receive the fastener 110 such that rotation of the fastener 110 relative to the threaded hole 106A produces controlled linear movement of the movable clamping member 108. The threaded engagement between the fastener 110 and the threaded hole 106A is configured to enable precise positioning and tightening of the movable clamping member 108 with respect to the support structures 106.

In one embodiment, the threaded hole 106A is oriented along a direction corresponding to a clamping axis of the clamp assembly 104, thereby facilitating radial inward movement of the movable clamping member 108 toward the neck portion of the vessel 126. The threaded hole 106A is further configured to maintain engagement with the fastener 110 under dynamic multi-axis motion conditions to prevent unintended loosening during operation.

In one embodiment, the threaded hole 106A is formed directly within the support structure 106 or is provided as an insert mounted within the support structure 106 to enhance durability and wear resistance.

In one embodiment, the movable clamping member 108 comprises an upper plate 108C and a lower plate 108D. The upper plate 108C and the lower plate 108D are mechanically coupled to each other through a plurality of spacers 108A. The spacers 108A are configured to maintain a fixed separation between the upper plate 108C and the lower plate 108D and to define a structural assembly capable of guided movement relative to the support structures 106.

In a preferred embodiment, the movable clamping member 108 comprises at least four spacers 108A arranged in a predefined pattern. The arrangement of the spacers 108A is configured to define at least two openings 108B extending between the upper plate 108C and the lower plate 108D. The openings 108B are configured to receive the fastener 110 such that the fastener 110 passes through the movable clamping member 108 and engages the threaded hole 106A of the support structures 106.

In one embodiment, the configuration of the upper plate 108C, the lower plate 108D, and the spacers 108A is further configured to enable stable translational movement of the movable clamping member 108 during actuation of the fastener 110 while preventing tilting or misalignment. The spacers 108A are further configured to maintain alignment of the upper plate 108C and the lower plate 108D under clamping forces and dynamic multi-axis motion conditions.

In one embodiment, the spacers 108A comprise cylindrical standoff members configured to maintain a fixed separation between the upper plate 108C, and the lower plate 108D. The spacers 108A are formed from metal, polymer, or composite materials selected to provide structural rigidity and resistance to deformation under clamping forces.

In another embodiment, the spacers 108A comprise threaded standoff elements configured to be removably secured between the upper plate 108C, and the lower plate 108D. The threaded standoff elements enable adjustment or replacement of the spacers 108A to modify spacing or accommodate different clamping configurations.

In another embodiment, the spacers 108A comprise sleeve-type members positioned around the fastener 110, wherein the sleeve-type members act as guide elements to maintain alignment of the upper plate 108C, and the lower plate 108D during movement of the movable clamping member 108.

In another embodiment, the spacers 108A are integrally formed with either the upper plate 108C or the lower plate 108D as protruding bosses or ribs, thereby eliminating separate spacer components and improving structural integrity of the movable clamping member 108.

In one embodiment, the movable clamping member 108 is configured to engage the neck of the vessel 126. The fastener 110 comprises an actuation fastener configured to move the movable clamping member 108 relative to the support structure 106.

In one embodiment, the movable clamping member 108 comprises a plurality of contact points. The contact points are configured to slide circumferentially around the neck during tightening of the actuation fastener 110 to thereby automatically center the vessel 126 and provide distributed contact forces. In a preferred embodiment, the movable clamping member 108 comprises at least eight contact points.

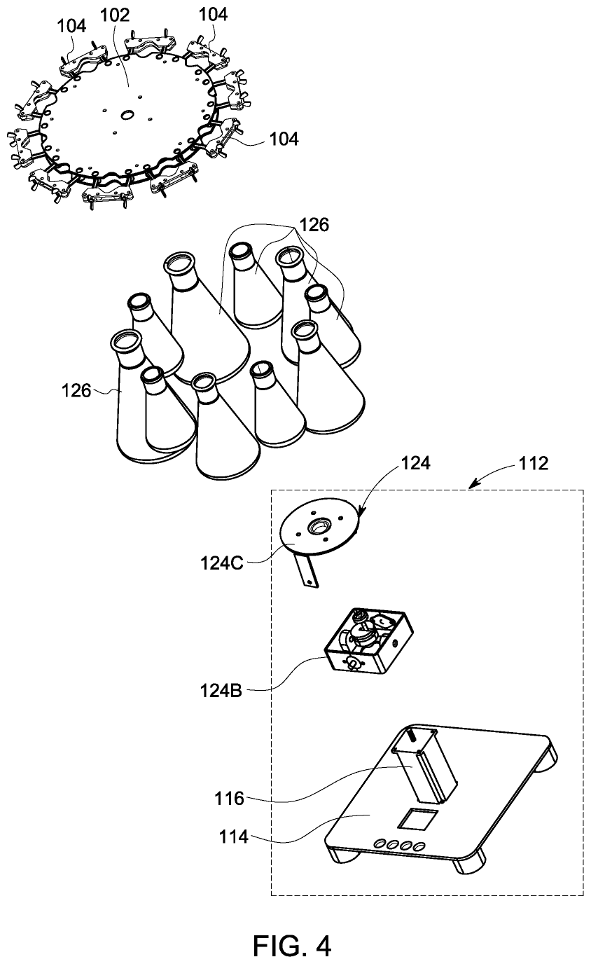

FIG. 4 refers to an exploded view of the multi-axis agitation apparatus 100. In one embodiment, the motion actuation assembly 112 comprises a base 114, a driving unit 116, a motion conversion unit 118, and a multi-frame structure 124. The base 114 is configured to provide a stable foundation for supporting the driving unit 116 and the multi-frame structure 124. The driving unit 116 is mounted on the base 114 and is configured to generate rotational motion for actuating the motion actuation assembly 112.

In one embodiment, the motion conversion unit 118 is operatively coupled to the driving unit 116 and is configured to modify a motion parameter of the motion actuation assembly 112. The motion conversion unit 118 is configured to vary an amplitude of motion transmitted from the driving unit 116 to the multi-frame structure 124, thereby enabling user-controlled adjustment of agitation intensity. In one embodiment, the motion conversion unit 118 is configured to convert rotational motion into displacement motion.

In one embodiment, the multi-frame structure 124 is operatively coupled to the driving unit 116 through the motion conversion unit 118 and is configured to convert rotational motion of the driving unit 116 into multi-axis motion. The multi-frame structure 124 comprises a plurality of interconnected frames arranged to allow movement along orthogonal axes that intersect at a common point. The multi-frame structure 124 is configured to support the movable platform 102 such that the movable platform 102 undergoes coordinated multi-axis motion while maintaining the longitudinal axis of each vessel 126 substantially vertical during motion.

In one embodiment, the motion actuation assembly 112 is configured to provide controlled, repeatable, and synchronized motion across all clamp assemblies 104 mounted on the movable platform 102, thereby enabling simultaneous agitation of multiple vessels 126 under uniform operating conditions.

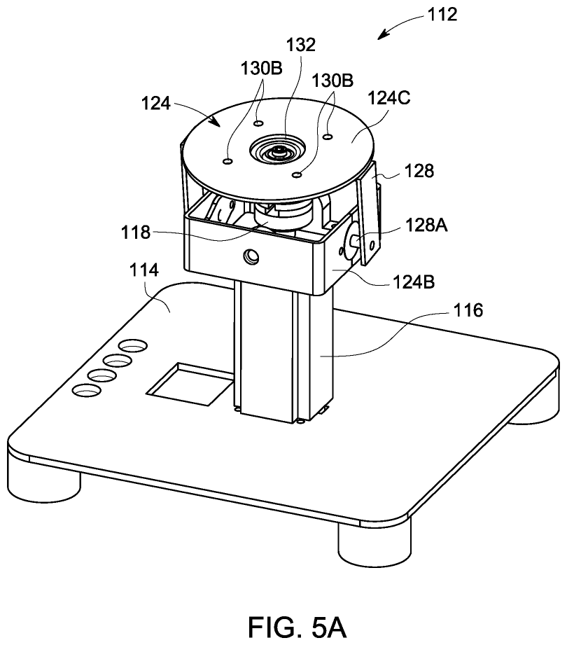

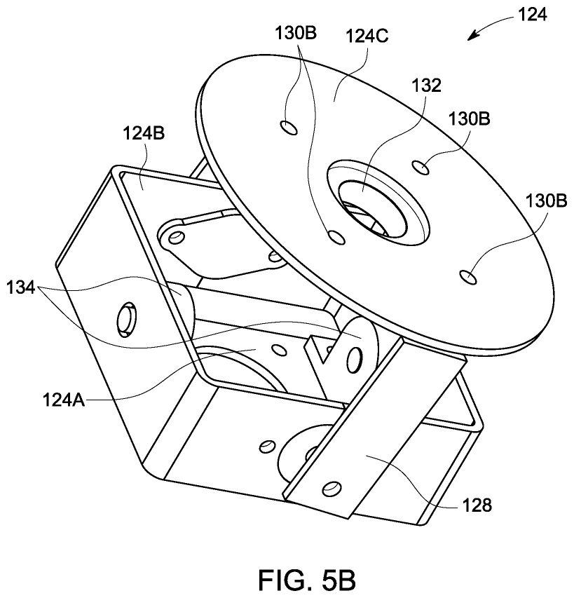

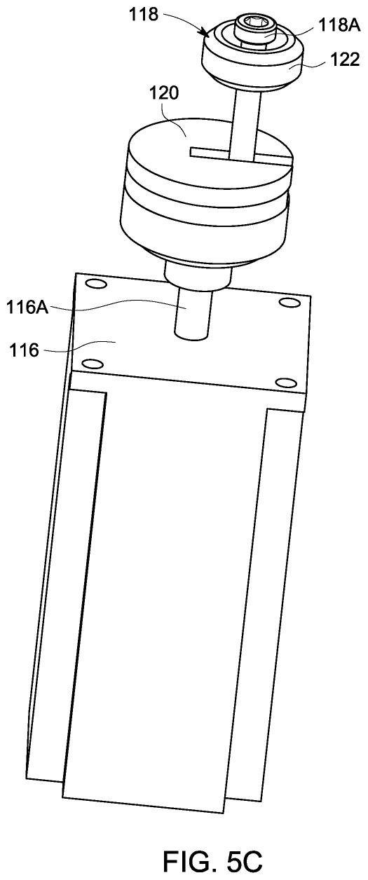

FIG. 5A refers to a perspective view of the motion actuation assembly 112 for operating the movable platform 102. FIG. 5B refers to a perspective view of the multi-frame structure 124. FIG. 5C refers to a perspective view of the motion conversion unit 118 without the multi-frame structure 124.

Referring to FIG. 5C, the driving unit 116 is mounted to the base 114. The driving unit 116 comprises a motor and a motor shaft 116A configured to generate rotational motion for actuating the motion actuation assembly 112. The motor is configured to provide a controlled rotational output to the motion conversion unit 118 for subsequent transmission to the multi-frame structure 124.

In one embodiment, the motor comprises an electric motor selected from a group consisting of a DC motor, an AC motor, or a stepper motor. The motor is configured to operate at a predefined rotational speed or within a variable speed range to accommodate different agitation requirements. The motor is further configured to maintain consistent rotational output under varying load conditions imposed by the movable platform 102 and the vessels 126.

In one embodiment, the driving unit 116 further comprises a mounting interface configured to rigidly secure the driving unit 116 to the base 114 to minimize vibration transfer losses and ensure efficient transmission of motion. The driving unit 116 is configured to transmit rotational motion along a defined rotational axis aligned with a crank 120 of the motion conversion unit 118.

In one embodiment, the motion conversion unit 118 is operatively coupled to the driving unit 116 through a motor shaft 116A. In a preferred embodiment, the motion conversion unit 118 comprises the crank 120 fixed to the motor shaft 116A such that rotation of the motor shaft 116A produces corresponding rotation of the crank 120. The motion conversion unit 118 further comprises a roller 122 mounted on the crank 120 at a radially adjustable position relative to a rotational axis of the crank 120.

In one embodiment, the motion conversion unit 118 coupled to the motor shaft 116A. The motion conversion unit 118 is configured to convert rotational motion of the motor shaft 116A into multi-axis displacement along at least three orthogonal axes intersecting at a common point. In a preferred embodiment, at least three rotational degrees of freedom corresponding to orthogonal axes intersecting at a common point.

In one embodiment, the motion conversion unit 118 further comprises an externally accessible screw 118A configured to adjust a radial position of the roller 122 with respect to the rotational axis of the crank 120. Adjustment of the radial position of the roller 122 defines a variable offset between the rotational axis of the crank 120 and a point of contact of the roller 122, thereby controlling a magnitude of displacement generated during rotation.

In one embodiment, variation of the radial offset modifies an amplitude of motion transmitted from the crank 120 to the multi-frame structure 124 and subsequently to the movable platform 102. The motion conversion unit 118 is configured to enable user-controlled variation of multi-axis agitation intensity through mechanical adjustment of the radial offset.

In one embodiment, the motion conversion unit 118 is configured to provide continuous or discrete variation in motion amplitude without altering a rotational speed of the driving unit 116, thereby decoupling amplitude control from motor speed control.

Referring to FIG. 5B, the multi-frame structure 124 is disposed on the driving unit 116. The multi-frame structure 124 comprises a plurality of frames arranged to allow motion along orthogonal axes that intersect at a common point. The multi-frame structure 124 comprises an inner frame 124A, a middle frame 124B, and an outer frame 124C corresponding to X, Y, and Z axes.

In one embodiment, the movable platform 102 is configured to support a plurality of vessels 126 is mounted on the multi-frame structure 124 such that rotation of the driving unit 116 produces controlled multi-axis motion of the movable platform 102.

In one embodiment, the outer frame 124C comprises a plurality of holes 130B. The holes 130B are configured to align with the holes 130A provided on the movable platform 102. The alignment of the holes 130B with the holes 130A is configured to enable insertion of fastener units for mechanically coupling the movable platform 102 to the outer frame 124C.

In one embodiment, the holes 130B are arranged in a predefined pattern corresponding to the hole pattern of the movable platform 102 to ensure accurate positioning and secure attachment. The holes 130B are configured as through-holes, threaded holes, or counterbored holes depending on a type of fastener unit employed.

In one embodiment, the aligned holes 130A and 130B are configured to facilitate transfer of motion from the outer frame 124C to the movable platform 102 while maintaining structural rigidity under multi-axis motion conditions. The configuration is further arranged to distribute mechanical loads evenly across the interface between the movable platform 102 and the outer frame 124C, thereby minimizing stress concentration and preventing misalignment during operation.

In one embodiment, the holes 130B is further configured to allow ease of assembly and disassembly of the movable platform 102 relative to the outer frame 124C for maintenance, replacement, or modular reconfiguration of the multi-axis agitation apparatus 100.

In one embodiment, the outer frame 124C comprises an aperture 132. The aperture 132 is configured to receive at least a portion of the roller 122 of the motion conversion unit 118. The aperture 132 is positioned on the outer frame 124C such that the roller 122 engages the outer frame 124C during rotation of the crank 120 to transmit motion from the motion conversion unit 118 to the multi-frame structure 124.

In one embodiment, the aperture 132 is dimensioned to accommodate movement of the roller 122 along a path defined by the radial offset of the roller 122 relative to the crank 120. The aperture 132 is configured to allow relative motion between the roller 122 and the outer frame 124C while maintaining mechanical engagement for effective transfer of motion.

In one embodiment, the aperture 132 comprises a slot, opening, or recessed channel configured to guide movement of the roller 122 during operation. The configuration of the aperture 132 is further arranged to prevent excessive play or misalignment of the roller 122 under dynamic multi-axis motion conditions.

In one embodiment, interaction between the roller 122 and the aperture 132 is configured to convert rotational motion of the crank 120 into translational or oscillatory motion of the outer frame 124C, thereby enabling transmission of controlled multi-axis motion to the movable platform 102.

In one embodiment, the inner frame 124A comprises a slot configured to align with the aperture 132 of the outer frame 124C. The slot is configured to permit at least a portion of the motion conversion unit 118, including the roller 122, to pass through the inner frame 124A and engage the outer frame 124C at the aperture 132.

In one embodiment, the slot is dimensioned to accommodate movement of the motion conversion unit 118 along a path defined by rotation of the crank 120 and a radial offset of the roller 122. The slot is configured to allow unobstructed passage of the roller 122 while maintaining proper alignment between the motion conversion unit 118 and the outer frame 124C.

In one embodiment, the middle frame 124B is coupled to the inner frame 124A through at least one hinged fastener 134. The hinged fastener 134 is configured to provide a pivotable connection between the inner frame 124A and the middle frame 124B, thereby enabling relative rotational movement of the middle frame 124B about a first axis.

In one embodiment, the hinged fastener 134 comprises a pin joint, pivot joint, or bearing-supported hinge configured to allow smooth and controlled angular displacement of the middle frame 124B with respect to the inner frame 124A. The hinged connection is configured to constrain movement to a defined rotational degree of freedom while restricting undesired translational motion between the inner frame 124A and the middle frame 124B.

In one embodiment, the hinged fastener 134 is positioned along a predefined axis corresponding to one of the orthogonal axes of the multi-frame structure 124, thereby contributing to generation of coordinated multi-axis motion. The hinged fastener 134 is further configured to maintain structural alignment between the inner frame 124A and the middle frame 124B under dynamic loading conditions during operation.

In one embodiment, the hinged fastener 134 is configured to support repeated cyclic motion while minimizing friction, wear, and mechanical play, thereby ensuring consistent transmission of motion within the multi-frame structure 124.

In one embodiment, the outer frame 124C comprises an elongated arm 128. The elongated arm 128 is pivotally coupled to the middle frame 124B through a pivoting fastener 128A. The pivoting fastener 128A is configured to provide a rotational joint between the elongated arm 128 and the middle frame 124B, thereby enabling relative angular movement of the outer frame 124C with respect to the middle frame 124B about a second axis.

In one embodiment, the pivoting fastener 128A comprises a pin, shaft, or axle configured to extend through aligned apertures provided in the elongated arm 128 and the middle frame 124B. The pivoting fastener 128A is configured to permit controlled rotational movement while maintaining positional alignment between the outer frame 124C and the middle frame 124B.

In one embodiment, the elongated arm 128 is configured to extend radially from the outer frame 124C to provide a lever structure that facilitates transmission of motion from the motion conversion unit 118 to the outer frame 124C. The configuration of the elongated arm 128 is further arranged to accommodate movement induced by the roller 122 while maintaining structural rigidity.

In one embodiment, the pivoting connection defined by the pivoting fastener 128A is aligned along an axis orthogonal to a rotational axis of the hinged connection between the inner frame 124A and the middle frame 124B, thereby contributing to generation of coordinated multi-axis motion within the multi-frame structure 124.

In one embodiment, the pivoting fastener 128A is configured to support repeated cyclic loading while minimizing wear and mechanical play, thereby ensuring consistent motion transmission during operation of the multi-axis agitation apparatus 100.

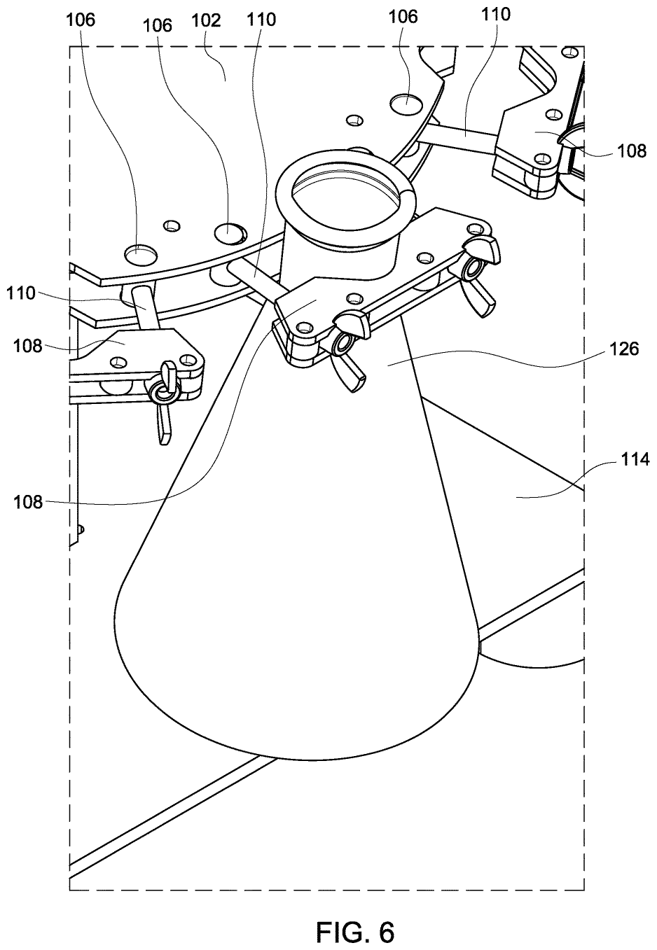

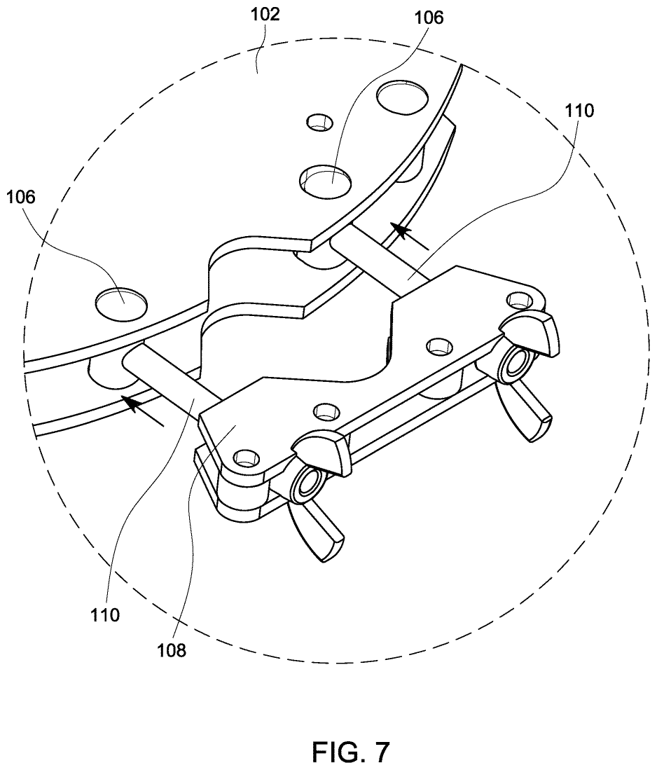

FIG. 6 refers to a perspective view depicting mounting of the vessel 126 on the multi-axis agitation apparatus 100. FIG. 7 refers to a perspective view depicting movement of the movable clamping member 108.

Referring to FIG. 6, a user is configured to mount the vessel 126 to multi-axis agitation apparatus 100 by positioning the clamp assembly 104 on the movable platform 102. The movable platform 102 comprises a plurality of clamp stations, each configured to receive and secure a corresponding vessel 126.

In one embodiment, the vessel 126 is positioned such that the neck portion of the vessel 126 is aligned within a receiving region defined between the support structures 106 of the clamp assembly 104. The support structures 106 provide a static reference framework for guiding placement of the vessel 126.

In one embodiment, prior to tightening, the movable clamping member 108 is positioned in an open configuration, thereby providing sufficient clearance for insertion of the neck portion of the vessel 126 between the contact points of the movable clamping member 108.

Referring to FIG. 7, upon positioning of the vessel 126, the fastener 110 is actuated, such as by manual rotation of a tee-wing screw. Rotation of the fastener 110 within the threaded hole 106A produces linear movement of the movable clamping member 108 relative to the support structures 106.

In one embodiment, movement of the movable clamping member 108 causes the contact points to move radially inward toward the neck portion of the vessel 126. The contact points are configured to slide circumferentially around the neck portion during tightening, thereby enabling automatic self-centering of the vessel 126 within the clamp assembly 104.

In one embodiment, the circumferential sliding of the contact points results in distribution of clamping forces across multiple contact regions around the neck portion of the vessel 126. This configuration ensures uniform pressure application and minimizes localized stress concentrations.

In one embodiment, tightening of the fastener 110 continues until the vessel 126 is securely retained within the clamp assembly 104. The clamp assembly 104 is configured to grip only the neck portion of the vessel 126 while leaving a body portion of the vessel 126 unsupported, thereby allowing unobstructed exposure of the vessel body during operation.

In one embodiment, once secured, the vessel 126 remains fixed relative to the movable platform 102, enabling transmission of motion from the motion actuation assembly 112 to the vessel 126 during operation. The self-centering configuration ensures that the vessel 126 remains aligned with a central axis of the clamp assembly 104, thereby improving stability under multi-axis motion conditions.

Similarly, multiple vessels 126 are mounted simultaneously across the clamp stations on the movable platform 102, thereby enabling concurrent agitation of multiple vessels 126 with uniform clamping and alignment.

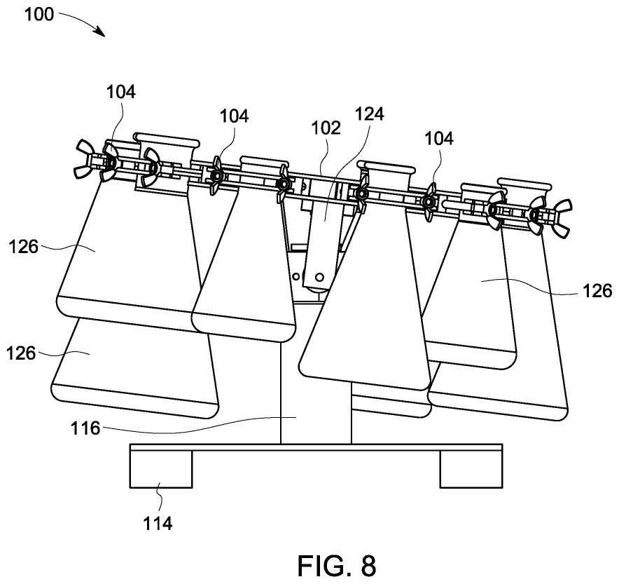

FIG. 8 refers to a perspective side view of the multi-axis agitation apparatus 100. In one embodiment, the motion actuation assembly 112 is configured to generate and transmit controlled multi-axis motion to the movable platform 102 for agitation of the vessels 126. The motion actuation assembly 112 comprises the base 114, the driving unit 116, the motion conversion unit 118, and the multi-frame structure 124, which cooperate to convert rotational motion into coordinated three-dimensional movement.

In one embodiment, the driving unit 116 comprises a motor mounted on the base 114 The driving unit 116 is configured to generate rotational motion about the motor shaft 116A. The motor shaft 116A is coupled to the crank 120 of the motion conversion unit 118 such that rotation of the motor shaft 116A produces corresponding rotation of the crank 120.

In one embodiment, the crank 120 rotates about a rotational axis defined by the motor shaft 116A. The roller 122 is mounted on the crank 120 at a radially offset position relative to the rotational axis. As the crank 120 rotates, the roller 122 follows a circular path defined by the radial offset.

In one embodiment, the motion conversion unit 118 comprises the externally accessible screw 118A configured to vary the radial offset of the roller 122 relative to the crank 120. Variation of the radial offset modifies a magnitude of displacement of the roller 122 during rotation, thereby controlling an amplitude of motion transmitted to the multi-frame structure 124.

In one embodiment, the roller 122 is configured to engage with the aperture 132 provided on the outer frame 124C. As the roller 122 moves along the circular path, the roller 122 exerts a force on the outer frame 124C through the aperture 132.

In one embodiment, interaction between the roller 122 and the aperture 132 converts rotational motion of the crank 120 into oscillatory or reciprocating motion of the outer frame 124C. The aperture 132 is configured to guide movement of the roller 122 while maintaining continuous mechanical engagement.

In one embodiment, the outer frame 124C is pivotally connected to the middle frame 124B through the elongated arm 128 and the pivoting fastener 128A. Movement of the outer frame 124C induced by the roller 122 is transmitted to the middle frame 124B through the pivoting connection, thereby enabling rotational motion about a second axis.

In one embodiment, the middle frame 124B is pivotally connected to the inner frame 124A through a hinged fastener. Movement transmitted from the outer frame 124C to the middle frame 124B is further transmitted to the inner frame 124A, enabling rotational motion about a first axis.

In one embodiment, the inner frame 124A comprises a slot aligned with the aperture 132 of the outer frame 124C. The slot is configured to allow passage of the roller 122 and maintain alignment of the motion conversion unit 118 with the outer frame 124C during motion transmission.

In one embodiment, the pivoting connections between the inner frame 124A, the middle frame 124B, and the outer frame 124C are arranged along orthogonal axes. The axes are configured to intersect at a common point, thereby enabling coordinated multi-axis motion of the multi-frame structure 124.

In one embodiment, motion imparted to the outer frame 124C by the roller 122 is transmitted through the middle frame 124B and the inner frame 124A, resulting in simultaneous rotational movement about multiple axes. This configuration produces a combined three-dimensional motion profile.

In one embodiment, the movable platform 102 is mounted on the outer frame 124C such that motion of the outer frame 124C is directly transmitted to the movable platform 102. The movable platform 102 undergoes coordinated multi-axis motion while maintaining the longitudinal axis of each vessel 126 substantially vertical during motion.

In one embodiment, the intersection of the motion axes at a common point ensures that the vessels 126 experience balanced motion without excessive tilting, thereby improving mixing efficiency and preventing spillage.

In one embodiment, the motion conversion unit 118 allows variation of motion amplitude by adjusting the radial offset of the roller 122 without altering the rotational speed of the motor. This enables independent control of agitation intensity.

In one embodiment, the motion actuation assembly 112 is configured to provide continuous, repeatable, and synchronized motion across all clamp assemblies 104, thereby enabling uniform agitation of multiple vessels 126.

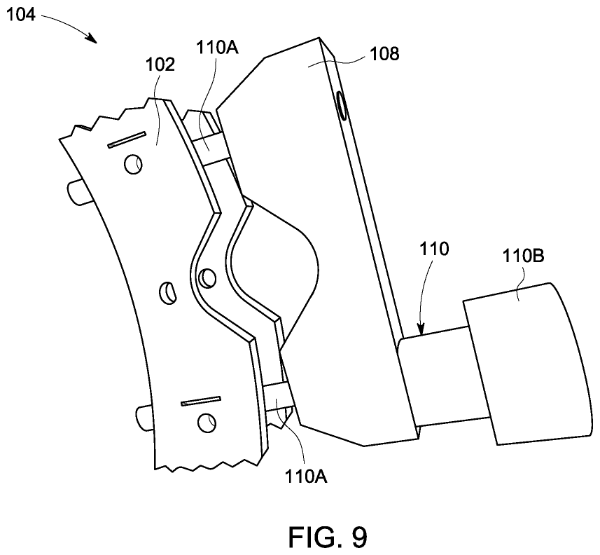

FIG. 9 refers to a perspective side view of at least one clamp assembly 104. In one embodiment, each of the clamp assemblies 104 comprises the support structure 106 and the movable clamping member 108. The support structure 106 is mounted on the movable platform 102, and the movable clamping member 108 is actuated by the fastener 110. The movable clamping member 108 is configured to engage the neck portion of a vessel 126.

In a preferred embodiment, the clamp assembly 104 has been updated for improved functionality. Instead of using two traditional tee-bolts, the fastener 110 comprises one tee-bolt has been replaced with a linear rod 110A to facilitate smooth movement and alignment of the movable clamping member 108. This modification reduces the number of moving parts involved in tightening, allowing for more consistent vessel placement and easier operation. The actuation fastener comprises the linear rod 110A and a torque bolt 110B. The movable clamping member 108 is guided by the linear rod 110A and actuated by a torque-limiting fastener configured to restrict applied clamping force. The torque bolt 110B comprises a torque-limiting clutch mechanism configured to slip when torque exceeds a threshold.

The other tee-bolt is replaced with the torque bolt 110B to prevent over-tightening of the neck of the vessel 126, which could lead to breakage. The torque bolt 110B is designed to exert a controlled amount of force, ensuring that the vessel 126 is securely held without the risk of damaging the neck portion. The torque bolt 110B effectively prevents excessive clamping force, thus reducing stress and strain on the vessel during operation.

In one embodiment, the clamp assembly 104 provides improved structural stability and controlled clamping force for holding vessels securely in place, while also mitigating the risk of damage caused by over-tightening.

The motion actuation assembly 112 is operatively coupled to the movable platform 102. The motion actuation assembly 112 is configured to impart multi-axis motion to the movable platform 102 such that the movable platform 102 moves along at least three axes intersecting at a common point while maintaining the longitudinal axis of each vessel 126 substantially vertical during motion.

In some embodiment, the movable clamping member 108 is actuated by the fastener 110 comprising a screw-actuation mechanism. In alternative embodiments, the movable clamping member 108 is actuated by one or more of a cam mechanism, a lever-actuated mechanism, a spring-biased mechanism, a ratcheting mechanism, or a motorized actuator. The screw actuation mechanism is configured to produce controlled movement of the movable clamping member 108 relative to the support structures 106 to secure the vessel 126. This configuration enables implementation of the clamp assembly 104 using different actuation architectures while maintaining self-centering functionality.

In an alternate embodiment, the movable clamping member 108 comprises the contact points configured to engage the neck portion of the vessel 126. The contact points comprise one or more of discrete contact points, arcuate segments, curved pads, rollers, or compliant surfaces. The contact points are constrained by the geometry of the upper plate 108C, the lower plate 108D, and the spacers 108A to move along the curved path such that each contact point undergoes combined radial inward movement toward the neck portion of the vessel 126 and circumferential displacement around the neck portion to center the vessel 126. The number, geometry, and arrangement of the contact points are variable depending on application requirements.

In another embodiment, the motion conversion unit 118 comprises the crank 120 and the roller 122 configured to provide adjustable radial offset. In alternative embodiments, the motion conversion unit 118 comprises one or more of an eccentric cam, a sliding linkage, an adjustable pivot arm, a variable-length linkage, or an offset disk mechanism configured to vary displacement amplitude. The motion conversion unit 118 is configured to modify a motion parameter, including amplitude, stroke length, or displacement magnitude, independent of rotational speed of the driving unit 116.

In some embodiment, motion transfer between the motion conversion unit 118 and the outer frame 124C is achieved through interaction between the roller 122 and the aperture 132. In alternative embodiments, motion transfer is achieved through one or more of a cam-slot interface, a follower mechanism, a sliding engagement, a bearing-guided interface, or a flexible coupling. The motion transfer interface is configured to convert rotational motion into translational, oscillatory, or multi-axis movement of the multi-frame structure 124.

In an exemplary embodiment, the multi-frame structure 124 comprises the inner frame 124A, the middle frame 124B, and the outer frame 124C arranged along orthogonal axes. In alternative embodiments, the multi-frame structure 124 comprises a gimbal structure, a nested frame arrangement, a parallel linkage mechanism, a flexure-based structure, or a spherical joint assembly configured to enable multi-axis motion. The axes of motion are configured to intersect at a common point or to approximate a common center of motion.

In another embodiment, the inner frame 124A and the middle frame 124B are coupled through a hinged fastener, and the middle frame 124B and the outer frame 124C are coupled through a pivoting fastener 128A. In alternative embodiments, the frames are coupled using one or more of bearings, ball joints, flexural joints, compliant hinges, or multi-degree-of-freedom joints configured to allow controlled rotational movement while maintaining alignment.

In another embodiment, the movable platform 102 is coupled to the outer frame 124C through aligned holes 130A and 130B and corresponding fastener units. In alternative embodiments, the movable platform 102 is coupled using one or more of quick-release fasteners, snap-fit connections, magnetic couplings, rail-based mounting systems, or modular docking interfaces configured to enable attachment and removal of the movable platform 102.

In some embodiments, the movable platform 102 comprises a plurality of clamp stations arranged in a fixed configuration. In alternative embodiments, the clamp assemblies 104 are repositionable, removable, or reconfigurable on the movable platform 102 to accommodate different vessel sizes, shapes, or arrangements. The movable platform 102 may further comprise adjustable mounting grids, slots, or modular attachment interfaces.

In another embodiment, the motion actuation assembly 112 provides mechanical adjustment of motion amplitude through the motion conversion unit 118. In alternative embodiments, the driving unit 116 is further configured to vary rotational speed, acceleration profiles, or motion patterns through electronic control, thereby enabling programmable agitation profiles in combination with mechanical amplitude adjustment.

In some embodiments, the multi-frame structure 124 further comprises damping elements, including elastomeric components, springs, or viscous dampers configured to reduce vibration, mechanical noise, and oscillation instability during operation. The damping elements are configured to improve motion smoothness and reduce mechanical wear.

In an exemplary embodiment, the components of the multi-axis agitation apparatus 100 comprise one or more of metals, polymers, composites, or hybrid materials. The components may be manufactured using machining, casting, molding, additive manufacturing, or fabrication processes. Material selection is configured to balance strength, weight, corrosion resistance, and manufacturability.

The multi-axis agitation apparatus 100 provides a self-centering clamp assembly 104 configured to secure vessels 126 through engagement with a neck portion, thereby enabling accommodation of vessels 126 having varying diameters without requiring dedicated clamp geometries. The movable clamping member 108, in cooperation with the support structures 106, ensures uniform distribution of clamping forces across multiple contact points, thereby improving stability and reducing risk of vessel damage.

The clamp assembly 104 is configured to grip only the neck portion of the vessel 126 leaving a body portion unobstructed. This configuration enables improved exposure of the vessel body for heating, cooling, or observation during operation, thereby enhancing experimental flexibility.

The movable platform 102 comprises a plurality of clamp assemblies 104 arranged in a modular configuration, thereby enabling simultaneous agitation of multiple vessels 126. This configuration increases throughput and operational efficiency compared to single-vessel agitation systems.

The motion actuation assembly 112 is configured to generate coordinated multi-axis motion through the multi-frame structure 124. The arrangement of the inner frame 124A, the middle frame 124B, and the outer frame 124C along orthogonal axes intersecting at a common point enables controlled three-dimensional agitation while maintaining the longitudinal axis of each vessel 126 substantially vertical during motion.

In another embodiment, the motion actuation assembly 112 is configured to convert input motion generated by the driving unit 116 into multi-axis motion through a motion conversion mechanism. The motion conversion mechanism comprises one or more of a crank-driven system, an eccentric mechanism, a cam-based system, a linkage assembly, or a hybrid mechanical transmission configured to transform rotational motion into multi-directional displacement of the multi-frame structure 124. The motion conversion mechanism is configured to generate controlled motion profiles including oscillatory, reciprocating, orbital, or compound motion.

In another embodiment, the roller 122 engages the aperture 132 to transmit motion to the outer frame 124C. In alternative embodiments, the interface between the motion conversion unit 118 and the multi-frame structure 124 comprises one or more of a cam-slot interface, a follower assembly, a sliding interface, a rolling contact interface, or a compliant coupling. The interface is configured to transmit motion while allowing relative movement between components under dynamic loading conditions.

In another embodiment, the multi-frame structure 124 comprises a plurality of frames arranged along orthogonal axes. In alternative embodiments, the multi-frame structure 124 comprises one or more of a gimbal assembly, a nested frame structure, a parallel linkage system, a spherical joint mechanism, or a flexure-based structure configured to enable multi-axis motion. The structure is configured to provide at least two or more degrees of freedom for motion transmission.

In another embodiment, the motion actuation assembly 112 is configured to impart motion having at least two degrees of freedom, including translational, rotational, or combined motion. The motion may comprise one or more of linear displacement, angular displacement, oscillatory motion, or compound trajectories defined by simultaneous movement along multiple axes.

In some embodiments, the driving unit 116 is further configured to operate in conjunction with a control system configured to regulate motion parameters including speed, acceleration, frequency, and motion patterns. The control system comprises one or more of a microcontroller, programmable logic device, or user interface configured to enable programmable agitation profiles.

In an alternate embodiment, the multi-axis agitation apparatus 100 further comprises one or more sensors configured to monitor operational parameters including vibration, position, load, or motion amplitude. The sensors are configured to provide feedback to the control system to enable adaptive adjustment of motion parameters.

In an alternate embodiment, the clamp assembly 104 is configured to secure vessels 126 of varying geometries including cylindrical, conical, square, or irregular shapes. The clamp assembly 104 is further configured to accommodate vessels formed from glass, plastic, metal, or composite materials.

In an alternate embodiment, the movable platform 102 is configured to distribute dynamic loads generated during multi-axis motion across the clamp assemblies 104. The platform 102 may comprise reinforcement structures including ribs, beams, or lattice structures configured to improve structural integrity while minimizing weight.

In an alternate embodiment, the base 114 further comprises vibration isolation elements configured to reduce transmission of motion to an external support surface. The isolation elements comprise one or more of elastomeric mounts, springs, dampers, or composite isolators configured to improve operational stability.

In an alternate embodiment, the multi-axis agitation apparatus 100 further comprises a locking mechanism configured to secure the movable platform 102 or the clamp assemblies 104 in a fixed position during loading and unloading of vessels 126. The locking mechanism comprises one or more of mechanical latches, detents, or locking fasteners.

The motion conversion unit 118 enables user-controlled variation of motion amplitude through adjustment of the radial offset of the roller 122 relative to the crank 120. This configuration allows independent control of agitation intensity without requiring modification of rotational speed of the driving unit 116, thereby simplifying operation and improving repeatability.

In an alternate embodiment, the multi-axis motion imparted by the motion actuation assembly 112 is generated through coordinated movement of the inner frame 124A, the middle frame 124B, and the outer frame 124C through respective pivoting connections, such that motion along each axis is mechanically defined and constrained by structural joints, thereby providing a physically realizable multi-axis motion system.

In an alternate embodiment, the multi-axis motion comprises motion along at least two or more independent axes selected from orthogonal axes, intersecting axes, or non-parallel axes, wherein the motion includes rotational, oscillatory, or combined displacement components.

In an alternate embodiment, circumferential movement of the movable clamping member 108 is achieved through relative sliding, rolling, or guided motion of the contact points around the neck portion of the vessel 126, such that self-centering is achieved through redistribution of contact forces irrespective of specific actuation mechanism.

In an alternate embodiment, variation of motion amplitude is achieved by modifying an effective displacement parameter of a motion conversion mechanism, including radial offset, eccentricity, linkage length, or pivot position, thereby enabling adjustment of motion characteristics through mechanical configuration.

In an alternate embodiment, the contact points comprise at least three contact regions arranged circumferentially around the neck portion of the vessel 126.

In an alternate embodiment, the motion actuation assembly 112 comprises physically interconnected mechanical components including the driving unit 116, the motion conversion unit 118, and the multi-frame structure 124, which cooperate to generate and transmit motion through defined mechanical linkages.

Interaction between the roller 122 and the aperture 132 of the outer frame 124C enables efficient conversion of rotational motion into oscillatory multi-axis motion. This configuration provides a mechanically simple and robust motion transmission mechanism with reduced complexity compared to electronically controlled systems.

The multi-frame structure 124 distributes motion across multiple axes through pivoting connections, including hinged fasteners and pivoting fasteners 128A, thereby enabling smooth and synchronized motion while minimizing mechanical stress and vibration.

The alignment of holes 130A on the movable platform 102 with holes 130B on the outer frame 124C enables secure attachment and efficient transmission of motion while maintaining structural rigidity under dynamic operating conditions.

The multi-axis agitation apparatus 100 is configured to provide consistent and repeatable agitation across all mounted vessels 126, thereby improving experimental reliability and reducing variability in mixing processes.

The modular and scalable design of the movable platform 102 and clamp assemblies 104 allows reconfiguration to accommodate different vessel arrangements and laboratory requirements, thereby enhancing adaptability and usability.

The mechanical configuration of the motion actuation assembly 112, including the motion conversion unit 118 and multi-frame structure 124, reduces reliance on complex electronic control systems, thereby improving durability, ease of maintenance, and cost-effectiveness.

The multi-axis agitation apparatus 100 provides improved adaptability to different vessel sizes, enhanced stability through self-centering clamping, and user-controlled adjustment of agitation intensity. The multi-axis agitation apparatus 100 further enables simultaneous and uniform agitation of multiple vessels 126, thereby improving throughput and operational efficiency.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principles of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It will readily be apparent that numerous modifications and alterations can be made to the processes described in the foregoing examples without departing from the principles underlying the invention, and all such modifications and alterations are intended to be embraced by this application.

The claimed invention is:

1. A multi-axis agitation apparatus, comprising:
a movable platform configured to support a plurality of vessels;
at least one clamp assembly mounted on the movable platform, wherein the clamp assembly comprises:
a support structure fixed relative to the movable platform; and
a movable clamping member coupled to the support structure by at least one threaded fastener, wherein the movable clamping member comprises:
an upper plate and a lower plate spaced apart by a plurality of spacers to form a guided assembly; and
a plurality of contact points disposed between the upper plate and the lower plate,
wherein the threaded fastener is engaged with a threaded hole of the support structure such that rotation of the threaded fastener produces linear translation of the movable clamping member relative to the support structure, and
wherein the contact points are constrained by the geometry of the upper plate, lower plate, and the plurality of spacers to move along a curved path, wherein each contact point undergoes combined radial inward movement toward a neck portion of a vessel and circumferential displacement around the neck portion to center the vessel,
a motion actuation assembly operatively coupled to the movable platform, wherein the motion actuation assembly comprises:
a driving unit having a motor shaft;
a motion conversion unit coupled to the motor shaft, wherein the motion conversion unit is configured to convert rotational motion of the motor shaft into multi-axis displacement along at least three orthogonal axes intersecting at a common point; and
a multi-frame structure coupled to the motion conversion unit and supporting the movable platform,
wherein the motion actuation assembly is configured such that rotation of the driving unit produces coordinated multi-axis motion of the movable platform while maintaining the longitudinal axis of each vessel substantially vertical during motion,
wherein the at least one clamp assembly and the motion actuation assembly cooperatively maintain vessel alignment during multi-axis motion through self-centering engagement of the neck portion.

2. The multi-axis agitation apparatus of claim 1, wherein the movable platform comprises a plurality of clamp stations arranged in a modular configuration.

3. The multi-axis agitation apparatus of claim 1, wherein the clamp assembly is configured to accommodate vessel neck diameters between 20 mm to 50 mm.

4. The multi-axis agitation apparatus of claim 1, wherein the clamp assembly is configured to grip only the neck portion of the vessel.

5. The multi-axis agitation apparatus of claim 1, wherein the movable clamping member is configured to provide at least eight circumferential contact points.

6. The multi-axis agitation apparatus of claim 1, wherein the movable clamping member is configured for radial inward movement.

7. The multi-axis agitation apparatus of claim 1, wherein the movable clamping member is free to rotate about respective dowels during tightening.

8. The multi-axis agitation apparatus of claim 1, wherein the at least one fastener comprises a screw, wherein the screw comprises a tee-wing screw configured for manual tightening.

9. The multi-axis agitation apparatus of claim 1, wherein the at least one fastener comprises a linear rod and a torque bolt, wherein the movable clamping member is guided by the linear rod and actuated by a torque-limiting fastener configured to restrict applied clamping force.

10. The multi-axis agitation apparatus of claim 1, wherein the driving unit comprises a motor.

11. The multi-axis agitation apparatus of claim 1, wherein the multi-frame structure comprises a plurality of frames arranged to allow motion along orthogonal axes that intersect at a common point.

12. A clamp assembly for securing a vessel, comprising:
a support structure;
a movable clamping member configured to engage a neck of the vessel;
at least one actuation fastener configured to move the movable clamping member relative to the support structure,
wherein the movable clamping member comprises a plurality of contact points configured to slide circumferentially around the neck during tightening of the at least one actuation fastener to thereby automatically center the vessel and provide distributed contact forces.

13. The clamp assembly for securing the vessel of claim 12, wherein the clamp assembly is configured to accommodate vessel neck diameters between 20 mm and 50 mm.

14. The clamp assembly for securing the vessel of claim 12, wherein the at least one actuation fastener comprises a tee-wing screw configured for manual tightening.

15. The clamp assembly for securing the vessel of claim 12, wherein the support structure comprises at least one threaded hole, which is configured to receive the actuation fastener such that rotation of the actuation fastener relative to the threaded hole produces controlled linear movement of the movable clamping member.

16. A motion actuation assembly for operating a movable platform, comprising:
a base;
a driving unit mounted to the base;
a motion conversion unit operatively coupled to the driving unit, wherein the motion conversion unit is configured to convert rotational motion into displacement motion; and
a multi-frame structure disposed on the driving unit, wherein the multi-frame structure comprises a plurality of frames arranged to allow motion along orthogonal axes that intersect at a common point,
wherein the movable platform is configured to support a plurality of vessels, which is mounted on the multi-frame structure such that rotation of the driving unit produces controlled multi-axis motion of the movable platform.

17. The motion actuation assembly of claim 16, wherein the motion conversion unit comprises an externally accessible screw configured to vary motion amplitude.

18. The motion actuation assembly of claim 16, wherein the multi-frame structure comprises an inner frame, a middle frame, and an outer frame corresponding to X, Y, and Z axes.

19. The motion actuation assembly of claim 16, wherein the driving unit comprises a motor.

20. The motion actuation assembly of claim 16, wherein the motion conversion unit comprises:
a crank coupled to the driving unit; and
a roller mounted on the crank with an adjustable offset,
wherein the motion conversion unit is configured to vary the adjustable offset of the roller relative to the crank.
